(19) United States
(12) Patent Application Publication
(10) Pub. No.: US 2016/0164880 A1
(43) Pub. Date: Jun. 9, 2016

(54) Systems And Methods Of Transaction Authorization Using Server-Triggered Switching To An Integrity-Attested Virtual Machine

(71) Applicant: Bitdefender IPR Management Ltd., Nicosia (CY)

(72) Inventors: Adrian V. COLESA, Cluj-Napoca (RO); Sandor LUKACS, Floresti (RO)

(21) Appl. No.: 14/558,922

(22) Filed: Dec. 3, 2014

(51) Int. Cl. H04L 29/06; G06F 3/0484; H04L 29/08

(52) U.S. Cl. CPC H04L 63/105; H04L 63/04; H04L 67/02; G06F 3/0484; H04L 63/083

(57) ABSTRACT

Described systems and methods allow a client system to carry out secure transactions with a remote service-providing server, in applications such as online banking and e-commerce. The server may evaluate each transaction to determine whether the transaction requires security clearance, according to criteria including, among others, a transaction amount, a location of the client system, and/or a history of transactions carried out for the respective user. In some embodiments, when the transaction requires security clearance, the server instructs the client system to switch to executing a secure virtual machine. In some embodiments, most transaction details (e.g., a selection of merchandise, an amount of a bank transfer, a delivery address) are sent to the server from a regular browser application, while a transaction authorization is sent to the server from within the secure virtual machine.

### BACKGROUND

The invention relates to systems and methods for securing electronic communication between a client and a remote service provider, and in particular systems and methods using hardware virtualization technology.

An increasing number of goods and services are currently provided online, through electronic communication networks such as the Internet. In some such applications, users may remotely access a protected resource such as a bank account through an e-banking platform hosted on a server computer system. To access the protected resource, users are typically required to provide some credentials, such as a password and/or an access code. In e-commerce applications, users may transmit sensitive information such as credit card details and/or other personal information to a remote computer system. Such sensitive data is typically input by the user into an electronic device such as a computer, mobile phone, etc. Subsequently, the sensitive information circulates over a communication network between the user's electronic device and the remote computer system.

Malicious software, also known as malware, affects a great number of computer systems worldwide. In its many forms such as computer viruses, worms, and rootkits, malware presents a serious risk to millions of computer users, making them vulnerable to loss of data and sensitive information, identity theft, and loss of productivity, among others. Malware may attempt to steal private or sensitive information, e.g., by intercepting keyboard inputs corresponding to a user's password or credit card number, or by intercepting communication between the malware-infected computer system and a remote computer system.

Other types of malware may attempt to alter the information sent between the infected computer system and the remote computer system. In one such example, commonly known as a man-in-the-browser attack, malware may corrupt a software application (e.g., a web browser) used to carry out online purchases or banking transactions. When a user attempts such a transaction, he or she will be allowed to enter payment data, e.g. an account number and an amount, and will receive a confirmation message showing the entered data. However, instead of the payment data input by the user, the infected browser will send to the remote server a modified set of payment data (e.g., a different account number and possibly a different amount).

Hardware virtualization technology allows the creation of simulated computer environments commonly known as virtual machines (VM), which behave in many ways as physical computer systems. Several virtual machines may run simultaneously on the same hardware platform (physical machine), sharing the hardware resources among them, thus allowing potentially a great number of users to share a computer system.

Since many modern applications (e.g., cloud-based services) operate in virtual environments, electronic communications are frequently carried out from within a virtual machine. Therefore, there is considerable interest in developing electronic communication devices allowing users to securely exchange data with remote computer systems, especially when such devices operate on hardware virtualization platforms.

### SUMMARY

According to one aspect, a server computer system is configured to receive transaction requests from a plurality of client systems. The server computer system is further configured to employ at least one processor of the server computer system to, in response to receiving a transaction request from a client application executing on a client system of the plurality of client systems, determine whether a transaction indicated by the transaction request requires security clearance. When the transaction requires security clearance, the server computer system is further configured to send a transaction token to the client system, the transaction token uniquely identifying the transaction among a plurality of transactions. The client system is configured, in response to receiving the transaction token, to switch to executing a secure virtual machine (VM) having a virtualized processor. Executing the secure VM comprises employing the virtualized processor to display an overview of the transaction to a user of the client system. Executing the secure VM further comprises, in response to displaying the overview, employing the virtualized processor to receive a user input indicating that the user agrees to the transaction, and in response to receiving the user input, employing the virtualized processor to send a transaction authorization to the server computer system. The transaction authorization is required by the server computer system to perform the transaction.

According to another aspect, a non-transitory computer-readable medium stores instructions which, when executed by at least one processor of a client system, cause the client system to form a hypervisor and a virtual machine (VM) launch module. The client system further operates a client application configured to send a transaction request to a remote server computer system. The server computer system is configured, in response to receiving the transaction request, to determine whether a transaction indicated by the transaction request requires security clearance. When the transaction requires security clearance, the server computer system is further configured to send a transaction token to the client system, the transaction token uniquely identifying the transaction among a plurality of transactions. The VM launch module is configured to detect a receipt by the client system of the transaction token. The hypervisor is configured to expose a secure VM on the client system, the secure VM comprising a virtualized processor, and in response to the VM launch module detecting the receipt of the transaction token, to switch the client system to executing the secure VM. Executing the secure VM comprises employing the virtualized processor to display an overview of the transaction to a user of the client system. Executing the secure VM further comprises, in response to displaying the overview, employing the virtualized processor to receive a user input indicating that the user agrees to the transaction, and in response to receiving the user input, employing the virtualized processor to send a transaction authorization to the server computer system. The transaction authorization is required by the server computer system to perform the transaction.

According to another aspect, a non-transitory computer-readable medium stores instructions which, when executed by at least one processor of a server computer system configured to receive transaction requests from a plurality of client systems, cause the server computer system, in response to receiving a transaction request from a client application executing on a client system of the plurality of client systems, to determine whether a transaction indicated by the transaction request requires security clearance. Executing the instructions further causes the server computer system, when the transaction requires security clearance, to send a transaction token to the client system, the transaction token uniquely identifying the transaction among a plurality of transactions. The client system is configured, in response to receiving the transaction token, to switch to executing a secure virtual machine (VM) having a virtualized processor. Executing the secure VM comprises employing the virtualized processor to display an overview of the transaction to a user of the client system. Executing the secure VM further comprises, in response to displaying the overview, employing the virtualized processor to receive a user input indicating that the user agrees to the transaction, and in response to receiving the user input, employing the virtualized processor to send a transaction authorization to the server computer system. The transaction authorization is required by the server computer system to perform the transaction.

### BRIEF DESCRIPTION OF THE DRAWINGS

The foregoing aspects and advantages of the present invention will become better understood upon reading the following detailed description and upon reference to the drawings where:

FIG. 1 shows an exemplary electronic communication system enabling secure transactions, the system comprising plurality of client systems are connected to a remote service-providing server via a communication network.

FIG. 2 illustrates an exemplary hardware configuration of a client system, according to some embodiments of the present invention.

FIG. 3 shows an exemplary hardware configuration of a service-providing server according to some embodiments of the present invention.

FIG. 4 shows an exemplary configuration of virtual machines (VM) executing on a client system according to some embodiments of the present invention.

FIG. 5 shows an exemplary set of steps performed by a client system to set up a secure communication environment according to some embodiments of the present invention.

FIG. 6 illustrates an exemplary data exchange between a client system and a service-providing server during a secure transaction performed according to some embodiments of the present invention.

FIG. 7 shows an exemplary sequence of steps performed by a client system and/or a service-providing server to carry out a secure transaction according to some embodiments of the present invention.

FIG. 8 illustrates an exemplary sequence of steps performed by a secure VM launch module to prepare the client system to switch to a secure VM, according to some embodiments of the present invention.

FIG. 9 shows an exemplary sequence of steps performed by a hypervisor to switch the client system from executing a client VM to executing the secure VM, according to some embodiments of the present invention.

FIG. 10 shows an exemplary sequence of steps performed by the client system to switch from executing the secure VM back to executing the client VM at the conclusion of a secure transaction, according to some embodiments of the present invention.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Unless otherwise specified, a hash is an output of a hash function. Unless otherwise specified, a hash function is a mathematical transformation mapping a variable-length sequence of symbols (e.g. characters, bits) to fixed-length data such as a number or bit string. Computer readable media encompass non-transitory media such as magnetic, optic, and semiconductor storage media (e.g. hard drives, optical disks, flash memory, DRAM), as well as communications links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

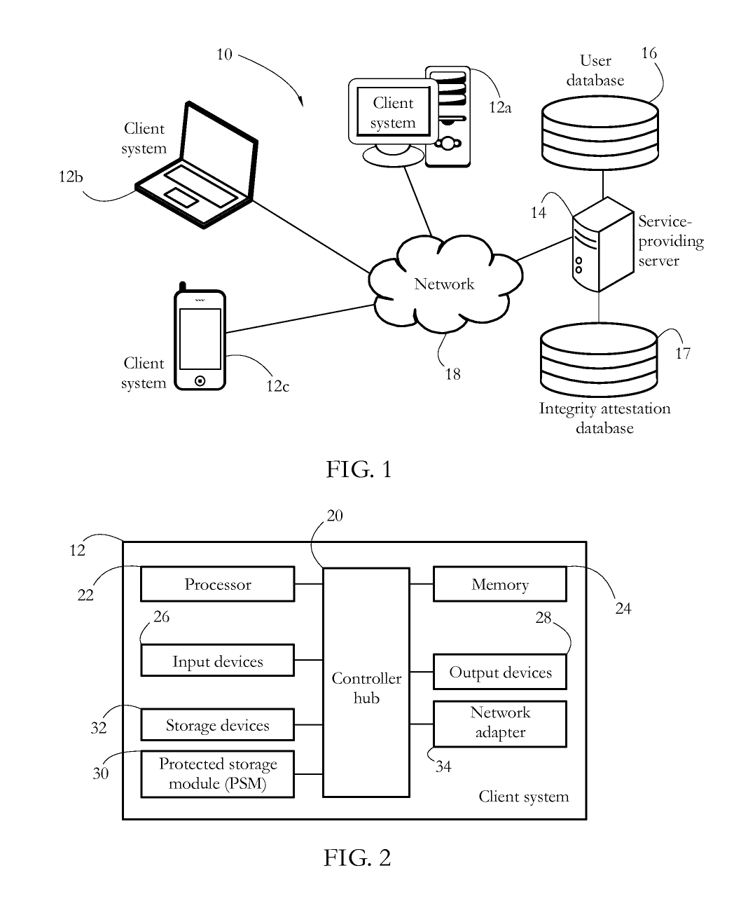

FIG. 1 shows an exemplary communication system 10 enabling secure transactions according to some embodiments of the present invention. System 10 comprises a service-providing server 14 and a set of client systems 12a-c, all connected via a communication network 18. Network 18 carrying data between server 14 and client systems 12a-c may be a wide area network such as the Internet, and may comprise a local area network (LAN) and/or a mobile telecommunication network.

Client systems 12a-c may represent corporate computing devices such as an enterprise server, or end-user devices such as a personal computer, tablet computer, or smartphone, among others. Other client systems include entertainment devices such as TVs and game consoles, wearable computing devices, or any other electronic device having a memory and a processor. In some embodiments, each client system 12a-c may be used by a single user (e.g., an employee of a company), or several users may access the same client system 12a-c (e.g. in work shifts, sales points operated by multiple employees, etc.).

In some embodiments, server 14 may provide services such as online banking, e-commerce, teleconferencing, and gaming, among others. An illustrative service-providing server 14 may host a webpage enabling users of client systems 12a-c to remotely access bank accounts via a web interface. Another example of server 14 hosts an online store offering goods and/or services to users of client systems 12a-c. Other illustrative service-providing servers may host financial services sites (e.g., online trading), entertainment sites (content streaming, gaming, dating, gambling, etc.) and/or social media sites. In some embodiments, server 14 comprises a plurality of interconnected computer systems, each having at least a processor and a memory, each possibly configured to carry out a distinct task. Each distinct computer system of server 14 may have a distinct network (e.g., IP) address. In one such example, one computer system of server 14 may be configured to expose an online store webpage, another computer system of server 14 may perform integrity verifications, while another computer system of server 14 may carry out a requested transaction (e.g. operate changes to a user's bank account). In an alternative embodiment, server 14 may operate a plurality of server virtual machines, each virtual machine configured to carry out a subset of tasks.

In some embodiments, service-providing server 14 is further connected to a user database 16 comprising a set of user-specific transaction preferences and/or policies. Such preferences/policies may define a manner in which server 14 provides services to each user. In some embodiments, server 14 allows certain transactions to be performed from a regular, possibly insecure environment (e.g., a common web browser), while requiring security clearance for other transactions. An exemplary security clearance requires receiving an authorization from a user, before carrying out the requested transaction. In some embodiments, the authorization allows server 14 to verify the identity of the respective user. To allow identification of the user, an authorization may comprise data which should only be known to the respective user, such as a password, passphrase, token-generated access key, credit card number, card authorization code, cryptographic key, etc. In alternative embodiments, the authorization required for security clearance comprises data indicating that the user has agreed to the respective transaction. For instance, security clearance may require that the user press a key or interact with a graphical user interface (GUI) element (e.g., a button). In some embodiments, the authorization indicator is delivered from a trusted, secure environment operating on the client system employed by the user to carry out the respective transaction, as shown in detail below. The authorization may be accompanied by a digitally signed integrity attestation package enabling server 14 to assess the trustworthiness of the respective secure environment.

In some embodiments, user-specific transaction preferences and/or policies enable server 14 and/or client systems 12a-c to determine whether a particular transaction requires security clearance. Transaction preferences may be explicitly indicated by each user, for instance as part of an enrollment process. An exemplary transaction preference may indicate a maximum allowable amount for an insecure transaction (i.e., transactions in amounts exceeding the maximum allowable require security clearance). Transaction policies may be defined by the service-providing entity. Such policies may be determined according to a time indicator, a location indicator, and a device type indicator, among others. In one example, transactions performed from a certain type of device (e.g., a laptop or desktop computer) may be allowed, while transactions attempted from other types of devices (e.g., smartphones) may require security clearance. In another example, server 14 may accept transactions from devices in certain geographical locations, or belonging to certain local-area networks, while requiring security clearance for transactions received from other locations/networks. Yet another exemplary transaction policy may instruct server 14 to request security clearance for transactions received within certain time intervals (e.g., outside regular business hours, during the night, on public holidays, etc.). In some embodiments, transaction policies may be combined with user preferences for more complex decision criteria. In one such example, a transaction may not require security clearance when it does not exceed a certain amount, when attempted within a certain hour interval, irrespective of the current location of the user. In another example, a transaction in the same amount may not require security clearance when performed from certain locations, but may require security clearance when attempted from other locations.

In some embodiments, transaction policies are determined automatically, according to a user's transaction history. In one such example, server 14 may gather a set of details for a plurality of transactions (e.g., type of merchandise, number of items purchased each time, delivery address, payment method), and use the set of details to infer a pattern of transactions specific to each user. Server 14 may then use the user-specific pattern as a transaction policy, for instance by requiring security clearance for transactions that do not fit within the respective user's pattern. Some policies may be rigid, while others may evolve in time, for instance to account for changes in a user's transaction behavior.

In some embodiments, server 14 is further connected to an integrity attestation database 17, comprising a set of reference measurements (e.g., hashes) allowing server 14 to remotely verify the integrity of selected software objects executing on client systems 12a-c. Further details of such attestation are given below.

FIG. 2 shows an exemplary hardware configuration of a client system 12, such as client systems 12a-c of FIG. 1, according to some embodiments of the present invention. System 12 represents a computer system for illustrative purposes; other devices such as smartphones may have a different configuration. System 12 comprises a set of physical devices, including a processor 22, a memory unit 24, a set of input devices 26, a set of output devices 28, a set of storage devices 32, and a set of network adapters 24, all connected by a controller hub 20. In some embodiments, processor 22 comprises a physical device (e.g. multi-core integrated circuit formed on a semiconductor substrate) configured to execute computational and/or logical operations with a set of signals and/or data. In some embodiments, such logical operations are delivered to processor 22 in the form of a sequence of processor instructions (e.g. machine code or other type of software).

Memory unit 24 may comprise volatile computer-readable media (e.g. RAM) storing data/signals accessed or generated by processor 22 in the course of carrying out instructions. Input devices 26 may include computer keyboards, mice, and microphones, among others, including the respective hardware interfaces and/or adapters allowing a user to introduce data and/or instructions into client system 12. Output devices 28 may include display devices such as monitors and speakers, among others, as well as hardware interfaces/adapters such as graphic cards, allowing client system 12 to communicate data to a user. In some embodiments, input devices 26 and output devices 28 may share a common piece of hardware, as in the case of touch-screen devices. Storage devices 32 include computer-readable media enabling the non-volatile storage, reading, and writing of processor instructions and/or data. Exemplary storage devices 32 include magnetic and optical disks and flash memory devices, as well as removable media such as CD and/or DVD disks and drives. The set of network adapters 34 enables client system 12 to connect to a computer network and/or to other devices/computer systems.

Controller hub 20 generically represents the plurality of system, peripheral, and/or chipset buses, and/or all other circuitry enabling the communication between processor 22 and devices 24, 26, 28, 32 and 34. For instance, controller hub 20 may include a memory management unit (MMU), an input/output (I/O) controller, and an interrupt controller, among others. In another example, controller hub 20 may comprise a northbridge connecting processor 22 to memory 24 and/or a southbridge connecting processor 22 to devices 26, 28, 32, and 34. In some embodiments, controller hub 20 also includes a power management controller, comprising circuitry/logic configurable to manage power consumption of client system 12, as directed by an operating system executing on system 12. The power management controller may be configurable according to the Advanced Power Management (APM) and/or Advanced Configuration and Power Interface (ACPI) standards.

In some embodiments, parts of controller hub 20 (such as the MMU) may be integrated with processor 22, i.e., may share a common substrate with processor 22. Some other devices, such as graphics adapters forming part of output devices 28, may be also integrated with processor 22.

Client system 12 may further include a protected storage module (PSM) 30. In some embodiments, module 30 is a hardware device, e.g. an integrated circuit, configured to securely store sensitive information. Such a PSM may comprise a persistent memory configured so that software executing on the respective client system may not overwrite a content of the persistent memory. In one typical application of such persistent memory, module 30 may store a cryptographic key uniquely associated with the respective module and/or with client system 12 in the persistent memory (such keys are sometimes called endorsement keys). Storage module 30 may further comprise a writable memory, configured so that selected software objects executing on the client system 12 are allowed to overwrite data stored in the writable memory. For instance, module 30 may be configured so that only software components of a hypervisor and/or other software executing at root level of processor privilege may have write permission to the writable memory (see more details below). In some embodiments, PSM 30 further comprises a cryptographic processor configured to generate cryptographic keys, to compute hashes, and/or to perform encryption/decryption of data. Exemplary protected storage modules 30 include trusted platform module (TPM) chips produced by various hardware manufacturers. In some embodiments, PSM 30 may be implemented in software (e.g., on ARM® platforms using TrustZone® extensions).

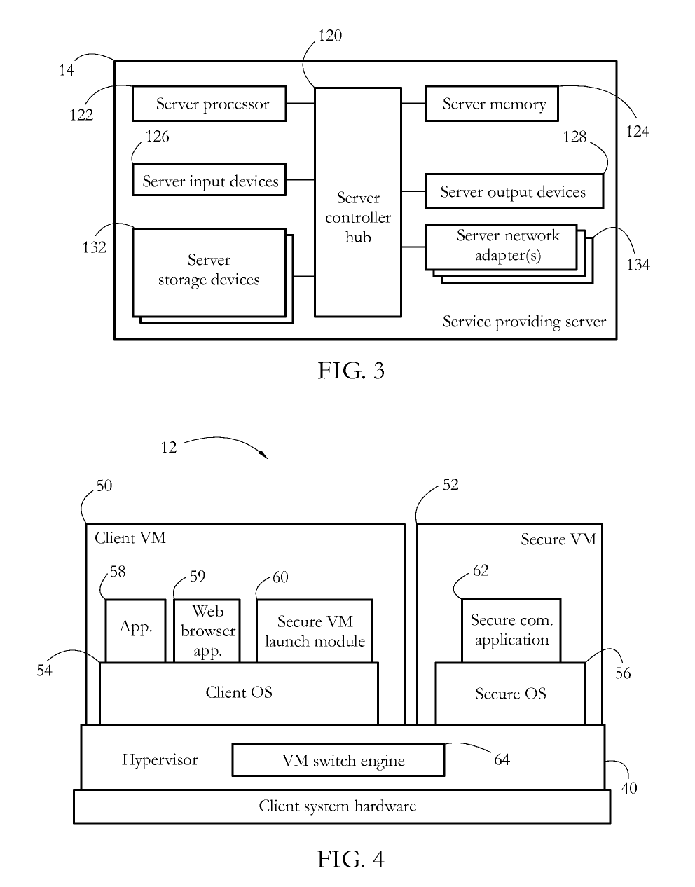

FIG. 3 shows an exemplary hardware configuration of service-providing server 14, according to some embodiments of the present invention. For reasons of simplicity, FIG. 3 shows a single computer system; in some embodiments, server 14 may include multiple such computer systems. Server 14 comprises a server processor 122, a server memory 124, server input, output, and storage devices 126-128-132, respectively, and server network adapters 134. Although devices 122-124-126-128-132-134 may differ in structural details and performance from devices 22-24-26-28-32-34 of client system 12, they have similar functionality, respectively. For instance, server processor 122 is configured to execute computational and/or logical operations with a set of signals and/or data according to a set of processor instructions, while such data may be stored in volatile computer-readable media of server memory 124.

FIG. 4 shows an exemplary configuration of virtual machines (VM) executing on client system 12 according to some embodiment of the present invention. The term “virtual machine” is commonly used in the art to denote an abstraction, e.g., a software emulation, of an actual physical machine/computer system, the VM capable of running an operating system and/or other software. In some embodiments, a hypervisor 40, also known in the art as a virtual machine monitor (VMM), executes on the client system hardware, enabling multiple virtual machines to operate on client system 12. Hypervisor 40 may include software configured to create and/or manage a plurality of virtualized devices, such as a virtual processor and a virtual controller, and to present such virtualized devices to software in place of the real, physical devices of client system 12. Such operations of hypervisor 40 are commonly known in the art as exposing a virtual machine. In some embodiments, hypervisor 40 only virtualizes a minimal set of hardware devices (e.g., processor 22, memory 24, and parts of controller hub 20), while allowing other hardware devices (e.g., input devices 16, output devices 18, and/or network adapters 34) to be accessed directly by selected virtual machines executing on the respective client system. Examples of popular hypervisors include the vSphere® from VMware Inc. and the open-source Xen hypervisor, among others.

In some embodiments of the present invention (e.g., FIG. 4), hypervisor 40 is configured to expose a client VM 50 and a secure VM 52. In some embodiments, hypervisor 40 further comprises a VM switch engine 64 configured to alternate execution between VM 50 and VM 52. Client VM 50 may be considered an insecure computing environment, in the sense that, in typical embodiments, client VM 50 executes software that is not specifically hardened or protected against internal or external malware attacks. For instance, client VM 50 may or may not include software explicitly configured to carry out secure transactions with server 14. In contrast, secure VM 52 includes components specifically designed to protect the user from malware attacks, and/or to ensure the security of transactions. The trustworthiness of security VM 52 is further enforced via integrity attestation by server 14, as shown in detail below.

Although FIG. 4 shows only two VMs for simplicity, in some embodiments hypervisor 40 may be configured to expose more than two VMs. In one such example, hypervisor 40 may expose one client VM 50 and a plurality of secure VMs 52, one secure VM for each of a plurality of uses, such as e-banking, e-commerce, gaming, etc. In such cases, hypervisor 40 may alternate execution so that no secure VM executes while the client VM is active.

In a preferred embodiment, secure VM 52 is allowed to execute only while client VM 50 is in a sleeping state, and client VM 50 is allowed to execute only while secure VM 52 is in a sleeping state, as shown in detail below. Sleeping states herein denote states with reduced power consumption, such as ACPI state S3, as opposed to active, high-power states such as ACPI state S0. In an alternative embodiment, hypervisor 40 maintains both client VM 50 and secure VM 52 in a high-power state (e.g., ACPI S0), and switches execution back and forth between client VM 50 and secure VM 52. Hypervisor 40 may further manage the switching so that, during execution of secure VM 52, secure VM 52 has exclusive access to the hardware of client system 12 (e.g., input and output devices, network adapter, etc.). In other embodiments, access to hardware may be shared securely between client VM 50 and secure VM 52, using, for instance, hardware drivers built into the hypervisor, which expose only virtualized hardware to VMs 50-52. In yet another embodiment, the hypervisor might configure hardware devices to be shared securely among several VMs, using hardware-accelerated device-sharing technologies such as PCI-SIG, Single Root I/O Virtualization (SR-IOV), and Intel® Graphics Virtualization (GVT).

In some embodiments, secure VM 52 is instantiated on-demand in response to a triggering event occurring within client VM 50. Hypervisor 40 may then terminate secure VM 52 when a secure transaction with server 14 concludes. On-demand instantiation may increase security, by preventing the persistence of software (e.g., of a malicious agent) within VM 52, between consecutive transactions with service-providing server 14. Exemplary instantiation triggering events include, among others, a user pressing a pre-determined combination of keyboard keys or clicking on a user-interface element (button, icon, etc.). Instantiation of secure VM 52 may also occur automatically, without a direct involvement of a user. For instance, secure VM 52 may be instantiated in response to client VM 50 receiving a notification from server 14.

Some embodiments may instantiate hypervisor 40 along with secure VM 52. In one such example, in the absence of a triggering event, hypervisor 40 is not loaded. In such a state, software executing on client system 12 may access hardware directly, without virtualization. The occurrence of a triggering event may launch hypervisor 40, which may further instantiate secure VM 52 and switch client system 12 to executing secure VM 52. Hypervisor 40 and/or secure VM 52 may be terminated when the respective transaction with server 14 concludes.

Software executing on a virtualized processor of a virtual machine is herein said to execute within the respective VM. In the exemplary embodiment of FIG. 4, applications 58-59-60 execute within client VM 50, while application 62 executes within secure VM 52. In contrast, hypervisor 40 is said to execute outside, or below, VMs 50-52.

In some embodiments, client VM 50 executes a client OS 54 and/or a set of software applications 58-59-60. Client OS 54 comprises software that provides an interface to the (virtualized) hardware of client VM 50, and acts as a host for applications 58-59-60 running within client VM 50. Client OS 54 may comprise any widely available operating system such as Windows®, MacOS®, Linux®, iOS®, or Android™, among others. Application 58 may generically represent a word processing, image processing, media player, database, calendar, personal contact management, gaming, voice communication, and data communication application, among others. Web browser application 59 includes software configured to send and retrieve data to/from a remote computer system over network 18 (e.g., using a data transfer protocol such as Hypertext Transfer Protocol—HTTP) and to display a visual representation of such data to a user. Popular examples of web browser applications include Internet Explore®, Firefox®, Safari®, and Chrome®, among others. In some embodiments, web browser application 59 comprises software configured specifically to perform transactions with a remote server (e.g., an online banking application, a gaming application, etc.).

A secure VM launch module 60 may execute within client VM 50 concurrently with applications 58-59. Secure VM launch module 60 may be configured to interface with hypervisor 40, e.g., to signal to hypervisor 40 to switch client system 12 from executing client VM 50 to executing secure VM 52 in response to detecting the occurrence of a trigger event. In a typical example, a user of client VM 50 intends to carry out a secure data exchange with service-providing server 14, for instance to perform an online banking transaction, or to purchase something from an online store. Such transactions are typically initiated using a web browsed application, e.g., application 59 in FIG. 4. In some embodiments, the user may input details of the transaction (e.g., may select merchandise, may indicate an amount of a banking transaction) into an online form exposed by the respective website. The user may then click on a button or on some other interactive element of the respective website, to send the data to server 14. In some embodiments, in response to receiving the data, server 14 may evaluate the requested transaction, to decide whether the respective transaction requires security clearance, and when yes, server 14 may instruct client system 12 to switch to executing secure VM 52 by returning a transaction token to client system 12. In some embodiments, secure VM launch module 60 detects the receipt of the transaction token, and interprets the receipt as a trigger event for launching secure VM 52. In an alternative embodiment, VM launch module 60 may detect the user's clicking on the respective web interface's send button and interpret such user action as a trigger for launching secure VM 52. In some embodiments, launch module 60 may evaluate the respective transaction locally, to determine whether the respective transaction requires security clearance, before triggering the launch of secure VM 52.

To carry out the described functionality, secure VM launch module 60 may be embodied as a component (add-on, plugin) of web browser application 59. Module 60 may also be installed as a standalone program, or may be part of a software suite including, among others, anti-malware, anti-spam, and privacy protection applications.

To communicate data from within client VM 50 to hypervisor 40 (e.g. to signal to hypervisor 40 to switch to executing secure VM 52), some embodiments may use an inter-process communication method known in the art of virtualization. In one example, secure VM launch module 60 may issue a particular function call (e.g., VMCALL on Intel® platforms), which triggers a processor event (e.g., VMExit on Intel® platforms) configured to suspend execution of client VM 50 and transfer control of processor 12 to hypervisor 40. Hypervisor 40 may include a handler routine, e.g., VM switch engine 64 in FIG. 4, configured to intercept the respective processor event, thus receiving notification from VM launch module 60. When processes executing within a virtual machine need to exchange data with hypervisor 40, such data may be placed in a pre-determined section of memory shared between the respective process (e.g., module 60) and hypervisor 40.

In some embodiments, secure VM 52 comprises a secure OS 56 and a secure communication application 62 executing on OS 56. Secure OS 56 may comprise a modified version of a widely available operating system such as Linux® or Android™, among others. An exemplary secure communication application 62 comprises a user interface allowing a user to exchange data with service-providing server 14, e.g., to review details of a current transaction and to transmit sensitive data such as a password, credit card number, etc., to server 14. Other examples of secure communication application 62 include a browser, a gaming application, and a social media application, among others. In some embodiments, secure VM 52 is launched by hypervisor 40 from an authenticated snapshot stored on a computer-readable medium of client system 12. In other embodiments, secure VM 52 and/or hypervisor 40 are loaded from a secure location accessible via network 18.

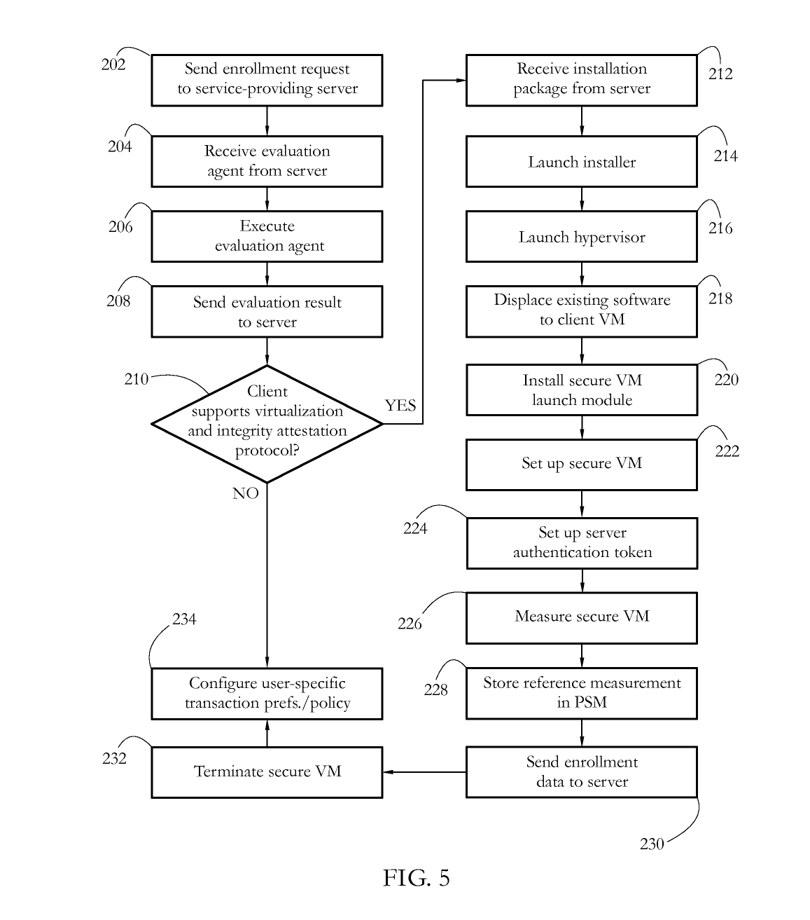

FIG. 5 shows an exemplary set of steps performed by a client system to set up a secure communication environment according to some embodiments of the present invention. In a step 202, client system 12 contacts service-providing server 14 with an enrollment request. In response, server 14 transmits an evaluation agent back to the requesting client system. In some embodiments, the evaluation agent determines whether the respective client system 12 supports virtualization and is capable of carrying out an integrity attestation exchange with server 14. In some embodiments, the evaluation agent determines certain details of the hardware of client system 12 (e.g., a make and/or model of processor 22, whether or not client system 12 includes a TPM chip, etc.) and makes the required determinations according to such hardware details. After receiving and executing the evaluation agent (steps 204-206), in a step 208 client system 12 transmits results of the evaluation to server 14. When the evaluation indicates that client system 12 either does not support hardware virtualization, or cannot carry out an integrity attestation exchange with server 14, client system 12 advances to a step 234 detailed below.

When the evaluation indicates that client system 12 supports hardware virtualization and integrity attestation, server 14 may transmit a VM installation package to client system 12, the package configured to set up client system 12 for secure communication with server 14. In a step 214, client system 12 launches the respective installation package. The package installs and launches hypervisor 40 (step 216). In response, in a step 218, hypervisor 40 exposes client VM 50 and displaces the software previously executing on client system 12 (e.g., client OS 54 and applications 58-59 of FIG. 4) to client VM 50. In an alternative embodiment, steps 216-218 comprise a reboot of client system 12. Following such a reboot, hypervisor 40 may expose VMs 50-52, and re-launch applications previously executing on client system 12, configuring such applications to execute within client VM 50. In a step 220, hypervisor 40 may install secure VM launch module 60, configuring module 60 to communicate with hypervisor 40.

Hypervisor 40 may then proceed to set up secure VM 52 (step 222). Such setting up may include, among others, configuring virtualized hardware devices of secure VM 52, and setting up data structures used by hypervisor 40 to manage execution of VM 52. Some client systems use a virtual machine state object (VMSO) to represent the current state of each virtualized processor exposed on the respective client system. Exemplary VMSOs include the virtual machine control structure (VMCS) on Intel® platforms, and the virtual machine control block (VMCB) on AMD® platforms. VMSOs are typically managed by hypervisor 40. In some embodiments, processor 22 associates a region in memory with each VMSO, so that software may reference a specific VMSO using a memory address or pointer (e.g., VMCS pointer on Intel® platforms).

Each VMSO may comprise a guest state area and a host state area, the guest state area holding the current CPU state corresponding to the execution of code within the respective guest VM, and the host state area storing the current CPU state corresponding to the execution of hypervisor 40. In some embodiments, the guest-state area of the VMSO includes contents of the control registers (e.g., CR0, CR3, etc.), instruction pointer (e.g., RIP), general-purpose registers (e.g., EAX, ECX, etc.), and status registers (e.g., EFLAGS) of the virtual processor of the respective guest VM, among others. The host state area of the VMSO may include a pointer (e.g., an EPT pointer on Intel® platforms) to a SLAT data structure configured for GPA-to-HPA address translations for the respective guest VM.

In some embodiments, processor 22 may store a part of a VMSO within dedicated internal registers/caches, while other parts of the respective VMSO may reside in memory. At any given time, at most one VMSO (herein termed the current VMSO) may be loaded onto the processor, identifying the virtual machine currently having control of processor 22. Modern processors are typically configured for multithreading. In such configurations, physical processor 22 may operate a plurality of cores, each core further comprising multiple logical processors, wherein each logical processor may process an execution thread independently of, and concurrently with, other logical processors. Multiple logical processors may share some hardware resources, for instance, a common MMU. In a multithreaded embodiment, a distinct VMSO may be loaded onto each distinct logical processor. In some embodiments, the number of configured VMSOs may exceed the number of distinct logical processors of client system 12, but at any time, the number of active VMSOs may not exceed the number of logical processors of the host platform.

In some embodiments, setting up secure VM 52 includes configuring a VMSO for secure VM 52. Setting up secure VM 52 may further comprise loading secure OS 56 and/or secure communication application 62 into memory, and configuring the state of the virtualized processor of secure VM 52 to indicate a readiness to execute application 62, for instance by appropriately adjusting the instruction pointer. In some embodiments, execution of step 222 thus creates a memory image of secure VM 52, ready for execution.

In a step 224, hypervisor 40 and/or the installer application may set up a server authentication token, which may be used to attest the identity of server 14 to a user of client system 12. In some embodiments, for transactions requiring security clearance, client system 12 receives the server authentication token from server 14, and displays the respective token to the user, to attest that the remote side of the current transaction is truly server 14, and not some hidden entity impersonating server 14. The server authentication token may comprise a secret known only to the respective user and to server 14. Exemplary server authentication tokens include, among others, an image, a sound, a password or passphrase, a famous quote, etc. The server authentication token may be uniquely associated to the respective client system (all users of the respective client system may use the same token) and/or to the respective user (each user of client system 12 has his/her server authentication token). To set up the token, step 224 may include requesting the user to specify a preferred image, passphrase, etc., to be used as a server authentication token in future secure transactions with server 14. In some embodiments, the server authentication token is selected by the user from a plurality of candidates provided by server 14. Alternatively, the user may be requested to supply the token (e.g., upload an image, type in a passphrase, etc.).

In a step 226, hypervisor 40 may perform a measurement of secure VM 52, to produce a reference value to be used for subsequent integrity verification of secure VM 52. Some embodiments verify the integrity of secure VM 52 before carrying out transactions with service-providing server 14 (as shown further below), to ensure that none of the components of secure VM 52 has been tampered with, for instance by malware infecting system 12. Several methods of integrity checking are known in the art. For instance, step 226 may compute a hash of the memory image of VM 52. A step 228 may save the respective hash, herein termed reference hash of VM 52, to the writable memory of protected storage module 30.

A step 230 may send enrollment data to server 14. Enrollment data may include, among others, a username or ID of a user of client system 12, the reference hash of secure VM 52, and the server authentication token determined in step 224. In some embodiments, enrollment data may further include a public cryptographic key associated to the respective user and/or client system. Further enrollment data may include measurements/hashes that can be used to verify the integrity of hypervisor 40 and/or of firmware or hardware-specific code (e.g., BIOS, UEFI) of client system 12. Enrollment data may be signed using a cryptographic key specific to the respective client system (e.g., the endorsement key of PSM 30). In response to receiving the enrollment data, server 14 may save such data (e.g., the reference hash of VM 52, the server authentication token, etc.) in attestation database 17. Reference hashes allow server 14 to subsequently verify the integrity of secure VM 52 before carrying out transactions requiring security clearance. In a further step 232, hypervisor 40 may terminate secure VM 52. In some embodiments, step 230 further comprises pre-allocating a section of memory for a future instance of secure VM 52.

In a step 234, client system 12 may configure user-specific transaction preferences and/or policies for a set of users of client system 12. Such preferences and/or policies indicate a set of criteria and/or parameters usable to determine which transactions with server 14 may be carried out from an insecure environment (e.g., client VM 50), and which transactions require security clearance. Such preferences/policies may be further stored in user database 16 (FIG. 1). Configuring transaction preferences/policies may proceed according to any method known in the art. In one example, server 14 sends to client system 12 an electronic form or user interface allowing a user to input personal preferences, such as a maximum amount of an unsecure transaction, preferred transaction devices, hours, locations, etc. In another embodiment, server 14 may gather such information over time, by analyzing a transaction history of each user to determine, for instance, a pattern of hours, locations, and/or devices specific to the respective user. Server 14 may then require security clearance for transactions which depart from the respective user's typical pattern, such as transactions occurring at odd hours, requesting shipping to unfamiliar addresses, or received from unusual geographical or network locations. When step 210 has determined that client system 12 does not support virtualization, or does not support integrity attestation, step 232 may include server 14 and/or client system 12 determining an alternative manner of securing transactions (e.g., telephonic confirmation by the user).

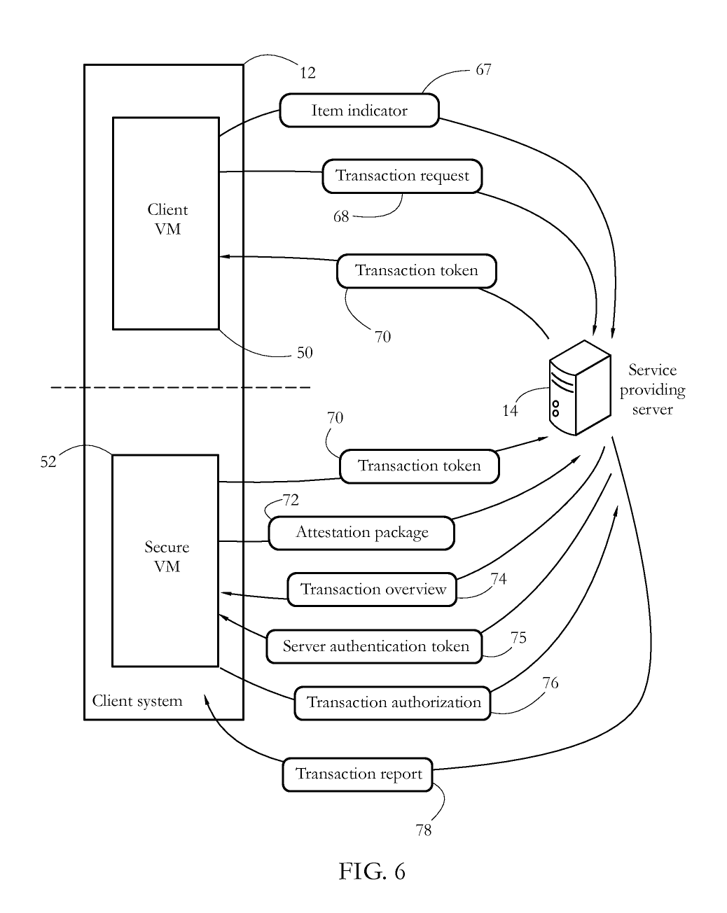

FIG. 6 illustrates an exemplary data exchange between client system 12 and service-providing server 14 during a secure transaction. In some embodiments of the present invention, client system 12 is configured to switch, during each transaction requiring security clearance, between executing client VM 50 and executing secure VM 52, so that a part of the data sent to server 14 during the respective transaction is sent from within client VM 50, while another part of the data is sent from within secure VM 52. The part sent from within client VM 50 includes, among others, an item indicator 67 and a transaction request 68. In some embodiments, item indicator 67 identifies a transacted item. In an online banking example, a transacted item may comprise a transfer of money from a source account to a destination account. In an e-commerce example, a transacted item may include a selection of merchandise (e.g., the contents of a shopping cart). Item indicator 67 may further include details such as an account number, a money amount, a delivery address, as well as an indicator of the buyer's identity (username, user ID, etc.). In some embodiments, item indicator 67 is included in transaction request 68.

The part transmitted from within secure VM 52 may include an attestation package 72 and a transaction authorization 76. In some embodiments, attestation package 72 comprises a current measurement of secure VM 52, enabling server 14 to verify the integrity of secure VM 52. Attestation package 72 may further include measurements/hashes usable to attest the integrity of hypervisor 40 and/or other critical software, such as firmware (e.g., BIOS, UEFI) executing on client system 12. In some embodiments, authorization 76 comprises data indicating that the respective user agrees to the current transaction. Such data may include, for instance, an indicator of whether the user has clicked an OK/submit button or some other GUI element enabling the user to show his/her agreement with the current transaction). Authorization 76 may further include a secret preferably known only to the user requesting the transaction. Exemplary secrets include, among others, a password or passphrase, a part of a credit card number (e.g., the last 4 digits), an access code, a card authentication code, and a cryptographic key.

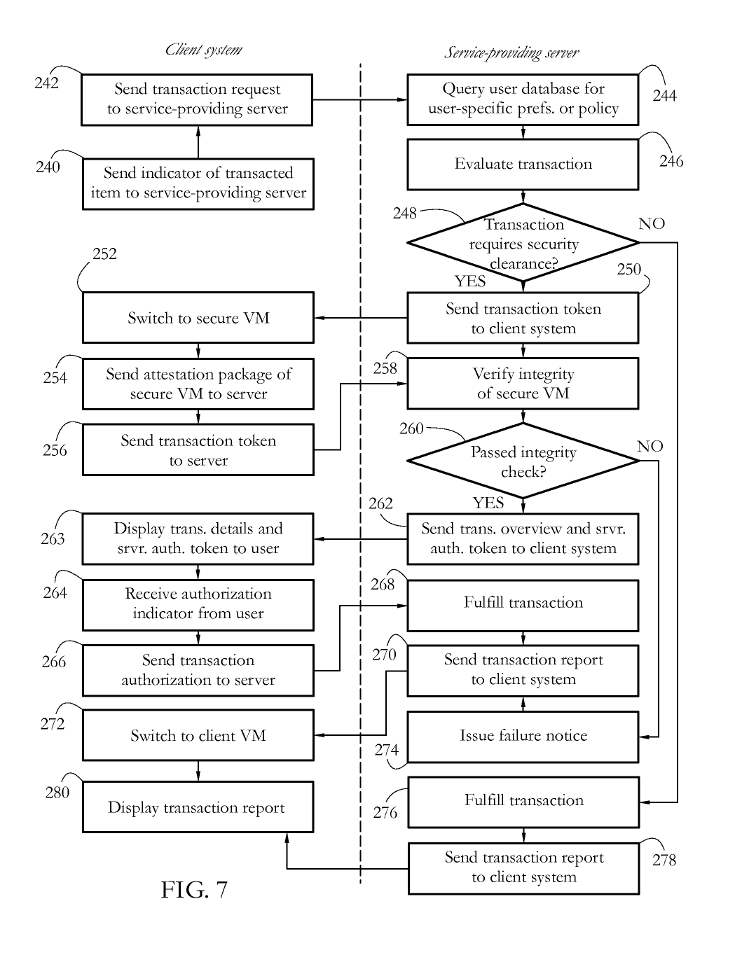

FIG. 7 illustrates an exemplary sequence of steps performed by client system 12 and/or service-providing server 14 to carry out a secure transaction according to some embodiments of the present invention. Typical online transaction models include two distinct stages of interaction between a user and a webpage managed by service providing server 14, the stages commonly known in the art as the shopping cart stage and the checkout stage. In some embodiments of the present invention, in the shopping cart stage, a user may employ application 59 to access the respective webpage and to set up details of a transaction. Such details may include an indicator of a transacted item. In an e-banking example, the shopping cart stage may include the user indicating a type of transaction (e.g., bank statement, money transfer, etc.), a recipient's name, a source and/or destination account number, an amount, etc. In an e-commerce example, the shopping cart stage may comprise the user accessing an online retail store to select merchandise for purchase. A step 240 may send such details to server 40, e.g., in the form of item indicator 67. Indicator 67 may be transmitted, for instance, as a parameter of a HTTP request. Although FIG. 7 illustrates transmitting indicator 67 in only one step, a skilled artisan will appreciate that step 240 may include a succession of individual data exchanges with server 14, possibly including multiple item indicators 67. A transaction may comprise multiple transacted items (e.g. a complex selection of merchandise, a complex bank transfer involving multiple source and/or recipient accounts, etc.). In such cases, each individual data exchange may correspond, for instance, to adding an item to a shopping cart.

Once details of the current transaction are set up, the user may be asked to proceed to the checkout stage, e.g., by clicking an appropriate button. In typical e-commerce applications, such buttons are inscribed “submit order”, “proceed to checkout”, etc. In response to the user indicating intent to proceed to the checkout phase (e.g. in response to the user clicking the respective button), in a step 242, client system 12 may send a transaction request 68 to server 14. Request 68 signals to server 14 that the user intends to carry out the current transaction. In some embodiments, transaction request 68 may include various transaction details, such as a transaction amount, a delivery address, etc. Request 68 may also include an item indicator identifying a transacted item (e.g, a selection of merchandise).

In response to receiving request 68, in a sequence of steps 244-246, server 14 may evaluate the respective request to determine whether a transaction indicated by request 68 requires security clearance. Such evaluation proceeds according to criteria and/or parameters defined as part of the user-specific transaction preferences/policies stored in user database 16. When the decision is made that the current transaction does not require security clearance, in a step 276, server 14 may fulfill the transaction without further authorization from the user. Fulfilling the transaction may comprise, for instance, registering a bank transfer, placing an order for merchandise, charging a credit card, etc., according to details of the respective transaction. In a further step 278, server 14 may send to client system 12 a transaction report 78 (FIG. 6) including a confirmation or a failure notice.

When the current transaction requires security clearance, in a step 250, server 14 returns a transaction token 70 (FIG. 6) to the respective client system. Token 70 includes a transaction identifier (e.g., a hash or a unique incremental ID) enabling server 14 to selectively identify the respective transaction from a plurality of transactions. Token 70 may be encrypted using a public key of client system 12 or of the respective user. In some embodiments, receiving transaction token 70 triggers client system 12 to automatically switch from executing client VM 50 to executing secure VM 52. In one such embodiment executing an automatic switch (i.e., without further action on the part of the user), secure VM launch module 60 may detect the receipt of token 70 and may signal to hypervisor 40. Module 60 may further transmit transaction token 70 to hypervisor 40, for instance by writing token data to a region of memory shared with hypervisor 40, and generating a VM exit processor event.

Switching client system 12 to executing secure VM 52 (step 252) comprises transferring control of processor 22 to VM 52. In some embodiments, switching to executing secure VM 52 comprises loading the VMSO associated with secure VM 52 onto the processor. Loading the VMSO results in processor 22 managing memory according to SLAT structures (e.g., extended page tables on Intel® platforms) configured for secure VM 52.

In an embodiment wherein hypervisor 40 is not in operation at the moment of the switch, step 252 may include first launching hypervisor 40 and subsequently instantiating secure VM 52. Instantiating VM 52 may include configuring and loading a VMSO of VM 52, and booting up or loading secure OS 56 and/or communication application 62. Instantiating secure VM 52 may also be achieved by loading into memory a ready-to-execute snapshot of VM 52 previously stored on storage devices 32 of client system 12.

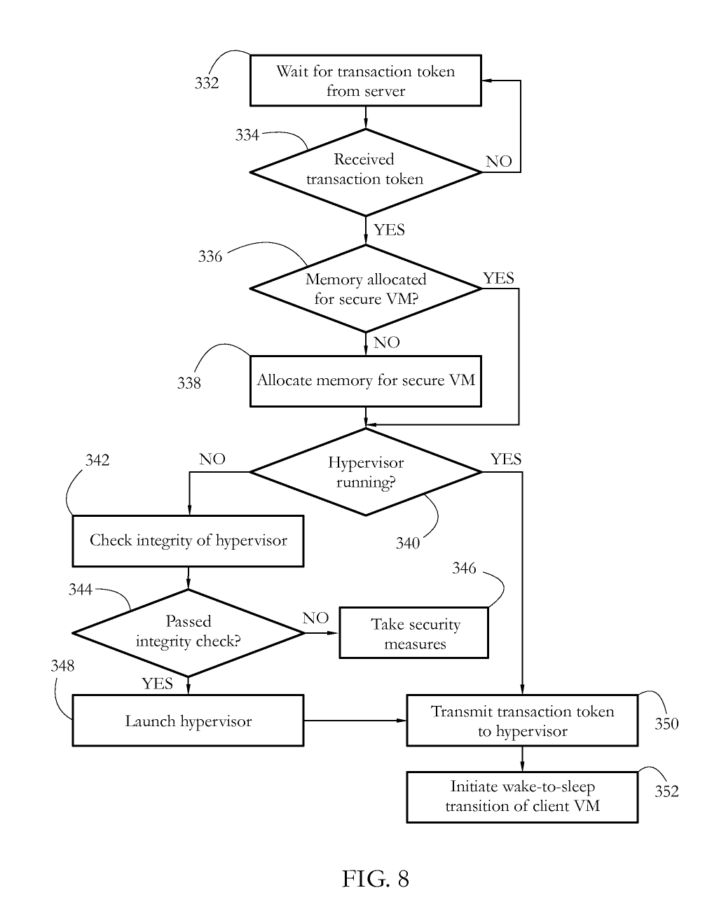

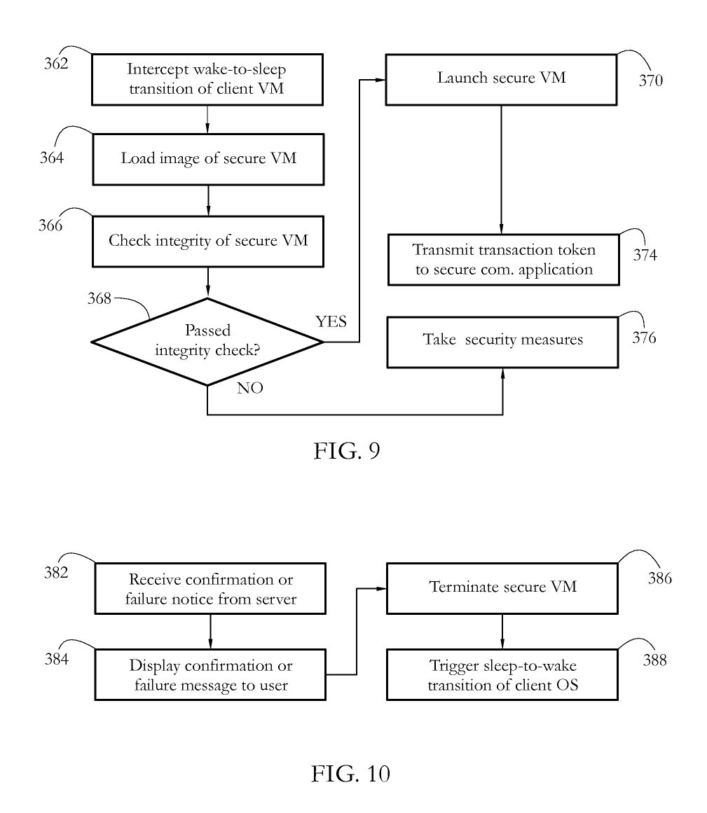

In a preferred embodiment, switching to executing secure VM 52 comprises transitioning client VM 50 into a low-powered state (e.g., standby, hibernation). Such embodiments prevent malware infecting client VM 50 from interfering with the operation of secure VM 52, for instance, to access input signals from input devices 26 or to read/write data from/to a display operated by secure VM 52. An exemplary sequence of steps performing such a switch via wake-to-sleep transitions is shown in FIGS. 8-9.

In a step 254, secure VM 52 may send an attestation package 72 (FIG. 6) to server 14. In some embodiments, package 72 includes a measurement (e.g., hash) of the current state of secure VM 52 and/or of hypervisor 40. The measurement may be signed using a cryptographic key specific to client system 12, for instance with an endorsement key of PSM 30. In some embodiments, package 72 is cryptographically signed with a public key of server 14. Such embodiments strengthen transaction security, by preventing a third party from masquerading as server 14 in exchanges with client 12. By being the only holder of the respective private key, server 14 should be the only entity capable of decrypting attestation package 72.

In a step 256, secure VM 52 sends transaction token 70 back to server 14 (server 14 may need token 70 to identify the current transaction among a plurality of transactions carried out with various clients). To carry out step 256, secure VM 52 needs to obtain token 70 from client VM 50. In some embodiments, hypervisor 40 obtains token 70 from client VM 50 (e.g., via a shared memory section), and transmits token 70 to secure communication application 62.

In response to receiving attestation package 72, in a step 258, service-providing server 14 verifies the integrity of secure VM 52, for instance by comparing the current measurement (hash) received with package 72 with the reference measurement (hash) stored for the respective client system in attestation database 17. A match indicates that the instance of the secure VM currently executing on client system 12 is in a trusted state. In some embodiments, step 258 further includes server 14 validating the digital signature received with attestation package 72. When integrity verification fails (e.g., in the case of a hash mismatch), in a step 274, server 14 issues a failure notice to be forwarded to client system 12.

When integrity verification indicates that secure VM 52 is in a trusted state, server 14 identifies the current transaction according to transaction token 70 and sends a transaction overview 74 to client system 12 (step 262). In some embodiments, transaction overview 74 includes transaction details specified by the user before checkout, i.e., before submitting the transaction request. Such details may include, for instance, a selection of merchandise, a destination account number, a transaction amount, a selected method of payment, etc. In response to receiving transaction overview 74, secure communication application 62 of secure VM 52 may display an overview of the current transaction to the user, allowing the user to verify the details of the current transaction.

In an alternative embodiment, transaction overview 74 does not contain transaction details per se, but only a digest (e.g., a hash) of such details. Such embodiments may substantially reduce the amount of data sent between client system 12 and server 14, since a hash may have a transaction-independent size of only a few bytes, in contrast to the actual transaction details which may vary in length and may consist of tens or hundreds of kilobytes of data (when images are included). A server-side digest may be calculated at server 14 according to item indicator(s) 67 and/or according to transaction request 68. In step 263, a client-side digest may be calculated by any module running inside secure VM 52, e.g., by secure communication application 62. The calculation of the client-side digest can be done using the same algorithm as the one used to determine the server-side digest. To calculate the client-side digest, communication application 62 may retrieve transaction details from insecure client VM 50, for instance via hypervisor 40. The locally-computed client-side digest can then be compared to the server-side digest received from server 14 as part of transaction overview 74. A match between the two digests may attest that the transaction details received from client VM 50 are identical with the details received by server 14, and have not been tampered with (for instance, by way of a man-in-the-middle attack). When the client-side digest does not match the server-side digest of the transaction, secure communication application 62 may display a warning to the user.

In some embodiments, step 263 may further enable the user to operate changes to the current transaction, before authorizing it. In one such example related to an e-commerce application, step 263 may display the contents of a shopping cart in itemized form, allowing the user (e.g. by way of an HTML form element), to remove an item, to change the quantity of a item, to change a delivery address or a payment vehicle, etc. Such embodiments may also allow the user to reject changes made to the current transaction by a possibly malicious entity (e.g. in a man-in-the-browser scenario).

In some embodiments, in step 262, server 14 also sends a server authentication token 75 (FIG. 6) to client system 12. Token 75 is configured by the user prior to the current transaction, e.g. as part of an enrollment process (step 224 in FIG. 5). Token 75 may be displayed to the user along with transaction overview 74 (step 263), allowing the user to verify that the remote side of the transaction is indeed server 14, and not some other entity masquerading as server 14. Since step 262 occurs only in response to a successful verification of the integrity of secure VM 52, the receipt of server authentication token 75 by client system 12 further attests to the user that secure VM 52 is in a trusted state. When the server authentication token is missing, or when the displayed token is not recognized by the user (indicating the possibility of a malicious man-in-the-browser attack), the user may refuse to authorize the transaction.

After displaying transaction details, secure VM 52 may request the user to authorize the current transaction. For instance, in a step 264, secure VM 52 may display a graphical element (e.g., an “OK”, “authorize”, or “place order” button) and wait for the user to click on it to indicate agreement. In some embodiments, secure VM 52 further requests the user to input a secret, e.g., a password, the last four digits of a credit card number, an authorization code, etc. When the user has expressed agreement to the transaction, in a step 266, secure communication application 62 transmits transaction authorization 76 (FIG. 6) to server 14.

In response, in a step 268, service-providing server 14 may fulfill the requested transaction. In a further step 270, server 14 may send a transaction report 78 (FIG. 6), including a confirmation or a failure notice, to the respective client system.

In response to receiving report 78, in a step 272, client system 12 may switch back to executing client VM 50. In some embodiments, step 272 includes a component of secure VM 52, for instance communication application 62, intercepting report 78. Application 62 may then signal to hypervisor 40 to switch client system 12 to executing client VM 52. Application 62 may further transmit report data to client VM 50, for instance to module 60. In a step 280, client VM 50 may display data from report 78 to the user, including an indicator of whether the current transaction was successful or not. When the transaction failed because server 14 could not verify the integrity of secure VM 52, client VM 50 may display a warning message to the user and/or send a warning message to a system administrator. An exemplary sequence of steps detailing the switch from secure VM 52 to client VM 50 is discussed below in relation to FIG. 10.

The exemplary sequence of steps in FIG. 7 refers to an embodiment of the present invention, wherein the decision whether a transaction requires security clearance is taken at service-providing server 14 (see step 246). In another embodiment, the decision may be taken by components executing within client VM 50, for instance by secure VM launch module 60, which may be an add-on or plugin of web browser application 59 used to carry out transactions. In such configurations, client launch module 60 may request transaction preferences/policies associated to the respective user from server 14. In an alternative embodiment, the user may explicitly request that the current transaction require security clearance (for instance, by clicking on a special button displayed by module 60). In yet another embodiment, the decision whether the current transaction requires security clearance may be taken according to local information about the user and/or about the transaction. Such local information may include, for instance, a history of transactions requested by the respective user from the respective client system. In one such example, module 60 may determine whether the current transaction falls within a known pattern of transactions of the respective user, and when no, module 60 may decide that the current transaction requires security clearance.

FIG. 8 shows an exemplary sequence of steps performed by secure VM launch module 60 to prepare client system 12 to switch from executing client VM 50 to executing secure VM 52, according to some embodiments of the present invention. The steps illustrated in FIG. 8 may form part of step 252 in FIG. 7.

In a sequence of steps 332-334, launch module 60 may wait for the receipt of transaction token 70 from server 14. When token 70 is received, in a step 336, module 60 determines whether memory is already allocated for an instance of secure VM 52, and when yes, module 60 advances to a step 340 described below. When no memory has been pre-allocated for secure VM 52, in a step 338, secure VM launch module 60 may instruct client OS 54 to allocate a section of memory for secure VM 52. In some embodiments, hypervisor 40 may determine addresses of memory pages allocated by client OS 54 to secure VM 52 using a page table mechanism (for instance, extended page tables—EPT on Intel® platforms). In an alternative embodiment, in step 338, hypervisor 40 may itself allocate the section of memory for secure VM 52, instead of instructing client OS 54 to do so.

In some embodiments, a step 340 determines whether hypervisor 40 is currently executing, and when yes, module 60 proceeds to a step 350 described below. When hypervisor 40 is not running, in a sequence of steps 342-348, module 60 may carry out a secure launch of hypervisor 40. In some embodiments, the secure launch of hypervisor 40 may be performed using a dedicated third-party technology such as Intel Trusted Execution Technology (TXT)®, or ARM TrustZone®, among others. Some of these methods load a software component known as a measured load environment (MLE), which then carries out the attestation of other components, such as hypervisor 40 and/or secure VM 52 (more details below).

In one exemplary embodiment, a step 342 checks the integrity of hypervisor 40, for instance by loading hypervisor 40 into memory, computing a hash of a memory image of hypervisor 40, and comparing the hash to a reference hash of hypervisor 40 stored in protected storage module 30 (such a reference hash may be determined upon installation of hypervisor 40). A hash match may indicate that the image loaded in memory is identical to the original image loaded at installation, thus confirming the integrity of hypervisor 40. A hash mismatch typically indicates that hypervisor 40 has been tampered with, usually by malware. When integrity is confirmed, a step 348 may launch hypervisor 40 into execution. When hypervisor 40 does not pass the integrity check, for instance if the hash computed in step 342 does not match the reference hash of hypervisor 40 stored in protected storage module 30, a step 346 may take anti-malware measures, such as alerting a user of client system 12 and/or blocking or otherwise restricting further execution of secure VM launch module 60.

In a step 350, module 60 may transmit transaction token 70 to hypervisor 40 for further transmission to secure VM 52. In a step 352, module 60 may then instruct client OS 54 to perform a wake-to-sleep transition. In some embodiments, the wake-to-sleep transition translates client VM 50 from a state with relatively high power consumption to a state with relatively low power consumption, by selectively powering down a subset of hardware devices. Operating systems typically manage power consumption via a power management interface configured according to the Advanced Power Management (APM) and/or Advanced Configuration and Power Interface (ACPI) specifications. The ACPI specification differentiates between a working state of a computer system and a sleeping state of the computer system, the sleeping state having several possible sub-states according to which hardware devices are powered, and which are turned off. The working state is commonly known in the art as S0, and is a state in which hardware devices used by the computer system are fully operational (powered). Sleeping states are usually labeled S1 through S4, with S3 commonly known as standby or suspend-to-RAM, and S4 commonly known as hibernation or suspend-to-disk. In some embodiments, the S3 state (standby) is characterized by the fact that random access memory (RAM) devices remain powered, and therefore the content of volatile memory units is preserved, while peripheral devices are in a low-powered condition or turned off (e.g., ACPI device state D3). In a typical S4 state (hibernation), the content of volatile memory is saved to a non-volatile storage device, and RAM is powered down together with peripheral devices. In some embodiments, the wake-to-sleep transition comprises a transition from an S0 (working) state to an S3 (standby) state.

FIG. 9 shows an exemplary sequence of steps performed by hypervisor 40 to switch client system 12 from executing client VM 50 to executing secure VM 52 according to some embodiments of the present invention. In a step 362, hypervisor 40 intercepts an event indicative of the wake-to-sleep transition initiated by secure VM launch module 60 in step 352 (FIG. 8). Wake-to-sleep transitions typically comprise a sequence of steps, such as disabling device drivers, saving a state of the respective devices to memory and/or disk, and instructing firmware, such as the Basic Input/Output System (BIOS) of client system 12, to actually power down the respective devices. In some embodiments, step 362 comprises employing hypervisor 40 to detect the execution of at least one of these steps. For instance, hypervisor 40 may detect an attempt by client OS 54 to write a particular value to a register of the power management interface, the value indicating to the BIOS to power down a hardware device. Since OS 54 executes within a virtualized environment, intercepting the attempt to write to the register of the power management interface may amount to intercepting an attempt by OS 54 to write to a memory page allocated by hypervisor 40 to the respective virtual register of the virtual power management interface of client VM 50. In some embodiments, step 362 may include intercepting an attempt by OS 54 to write to an I/O port.

Following a successful interception of the wake-to-sleep transition, hypervisor 40 may switch client system 12 to executing secure VM 52. A step 364 loads a image of secure VM 52 into the section of memory allocated to secure VM 52 by client OS 54 (step 338 in FIG. 8). In some embodiments, the image is produced by module 60 and/or hypervisor 40 during the installation phase (FIG. 5). The image of secure VM 52 may also be pre-fabricated remotely and delivered to client system 12 as part of an installation package.

Switching to executing secure VM 52 may further comprise, in a step 366, checking the integrity of secure VM 52, for instance by computing a hash of the loaded memory image of secure VM 52, and comparing the hash to a reference hash stored on protected storage module 30 (see step 228 in FIG. 5). A hash match may indicate that the current instance of secure VM 52 is identical to the initial image set up at installation, thus verifying the integrity of secure VM 52. When the integrity of secure VM 52 is verified, a step 370 may launch secure VM 52 into execution. In a further step 374, hypervisor 40 may transmit transaction token 70 to secure communication application 62. When the integrity check fails, secure VM 52 may be compromised by malware; therefore, a step 376 may take anti-malware measures, such as alerting a user and/or blocking execution of secure VM 52.

FIG. 10 shows an exemplary sequence of steps performed by client system 12 to switch from executing secure VM 52 back to executing client VM 50 in an embodiment using wake-to-sleep transitions. In some embodiments, the trigger for such a switch includes the receipt of transaction report 78, which may detected, for instance, by secure communication application 62 (step 382). In response, in a step 384, application 62 may display a confirmation/failure notice to the user. Application 62 may further signal to hypervisor 40, for instance by issuing a specific processor instruction (e.g., VMCALL on Intel® platforms), thus triggering a VM exit event. Control of processor 22 then passes on to hypervisor 40, which may terminate secure VM 52 (step 386). Terminating secure VM 52 may prevent changes occurring within secure VM 52 during a secure transaction to persist between consecutive instances of secure VM 52 (such changes may be made by a malicious agent). Next, in a step 388, hypervisor 40 may induce a sleep-to-wake transition of client OS 54, thus restoring the environment of client VM 50.

The exemplary systems and methods described above enable a client system supporting hardware virtualization to expose a secure environment, which can be used to authorize electronic transactions in applications such as online banking, e-commerce, private messaging, and online gaming, among others. In some embodiments, a hypervisor switches the client system between executing an insecure environment and executing the secure environment for the purpose of authorizing a transaction. In some embodiments, switching to the secure environment comprises transitioning the insecure environment into a sleeping state of power management, such as standby or hibernation, and loading a secure virtual machine (VM) from a memory image stored to disk. Switching from the secure to the insecure environment may comprise transitioning the secure VM into a sleeping state and waking up the insecure environment (client VM).

In conventional computer systems, malware can compromise the safety and privacy of data exchange. Such systems may employ malware scanners to try to ensure that a client system does not comprise malware, before attempting to exchange sensitive information with a remote party. Malware scanners may place a significant burden on the computational resources of a client system, and may reduce overall productivity and increase the cost of operation of the client system. Additionally, the effectiveness of malware scanners may depend essentially on the ability to maintain up-to-date databases of malware-identifying features and/or behaviors, to cope with the ever-changing nature of malware. In contrast, some embodiments of the present invention do not require a malware scanner for operation. Instead, security-critical communication with remote parties is carried out from a secure environment, configured as a separate, authenticated, trusted virtual machine. The secure VM is allowed to execute only when its memory image is found to be identical to a previously stored, malware-free reference image.

In typical hardware virtualization configurations, a plurality of virtual machines may execute concurrently on one client system, with various degrees of isolation. In such systems, carefully-crafted malware may compromise the security of communication, for instance by intercepting keyboard inputs such as passwords and credit card details. In contrast, in some embodiments of the present invention, the insecure client VM and the secure VM don't share the use of peripheral devices, such as a keyboard and a network adapter. One particularly effective way to ensure such isolation is to transition the insecure environment to a sleeping state for the duration of execution of the secure VM. When a user types a password on a keyboard or receives sensitive information on a screen while the keyboard and the screen are controlled by the secure VM, malware loaded into the insecure environment may not intercept such data, since the insecure environment is currently in a state wherein no code is executed and peripheral devices are switched off.

Having a configuration wherein either the insecure client VM or the secure VM are in a sleeping state, while the other is executing, allows some embodiments of the present invention to use a minimal, thin layer hypervisor instead of a fully featured one. For instance, the hypervisor may be configured to virtualize only a relatively small subset of physical devices, such as the processor, memory, and some controller devices. Instead of virtualizing I/O and/or peripheral devices, such as a graphic adapter, keyboard, and/or network adapter, some embodiments allow the virtual machines executing on the client system to access such devices directly, without the virtualization layer present in typical virtualization applications. Such configurations may carry substantially lower performance penalties compared to fully-virtualized configurations, and may therefore contribute to a more pleasant user experience, especially on mobile platforms such as smartphones and tablet computers.

In some embodiments, the hypervisor automatically switches the client machine from executing the insecure environment to executing the secure environment, as opposed to requesting user input to perform the switch (e.g., the user pressing a button or clicking on a GUI element). In one such example, switching from the insecure to the secure environment is triggered by receiving a specific signal from the service-providing server. Such configurations may increase security, by not relying on the user to decide whether to conduct communication with the server from the insecure or from the secure environment. In some embodiments, the decision whether to enable the secure environment is taken at the service-providing server, according to particularities of each transaction.

In some embodiments, the secure environment is only used for authorizing a selected subset of transactions, e.g., only for transactions requiring security clearance. Such transactions may include, for instance, transactions exceeding a pre-determined amount, transactions occurring within certain time intervals, transactions performed from certain devices, such as a mobile phone or tablet computer, or transactions occurring from certain geographical or network locations. The decision whether a particular transaction requires security clearance may be taken according to pre-defined user-specific preferences or policies. Enabling the secure environment only for a selected subset of transactions (e.g., the really important ones, or the ones with the highest security risk) may improve the overall user experience, by reducing the computational load on the client system and by reducing the number of times the user is asked to authorize transactions or to provide additional, possibly sensitive, information to the server.

In some embodiments, a part of a transaction is performed from the insecure environment, and another part is performed from the secure environment. In one such example, the user may initiate the transaction and carry out most of the operations associated with the transaction from a regular browser application executing within the insecure environment. For instance, in the case of a purchase from an online retailer, the user may use the regular browser to access the retailer's storefront webpage, log into his/her account, select merchandise, fill in a delivery address, select a payment method, etc. Such details may be sent to the server from the insecure environment, e.g., when the user clicks a submit button of an online form. To complete the transaction, the service-providing server may then require an authorization from the user. The authorization may comprise just an indication that the user agrees to the transaction, or may further include some sensitive user-provided data, such as a password, the last four digits of a credit card, etc. In some embodiments, the user's authorization is sent to the server from within the secure environment, along with a measurement that allows the server to verify the integrity of the secure environment. To ensure that the respective transaction authorization is sent from the secure VM, the client system may automatically switch from executing the insecure environment to executing the secure VM, in response to a signal from the server.

Some embodiments further allow the user to verify that the transaction authorization is indeed handled by a trusted server, as opposed to an entity masquerading as the respective server (e.g., in a man-in-the-middle attack). In one such example, the server sends an authentication token to the requesting client system, along with details of the transaction requiring authorization. The token may be an item familiar to the user (e.g., a familiar image, sound, passphrase, etc.), and may be specified by the user prior to sending the transaction request to the server. In some embodiments, the server authentication token is displayed to the user by the secure VM. Receipt of the token in relation to a current transaction may attest to the user that the remote party in communication with the client computer system is indeed the trusted server computer system. An alternative embodiment may prevent man-in-the-middle attacks using encryption (e.g., transmissions to the server may be encrypted using a public key of the server; transmissions to the client may be encrypted using a public key of the client).

In some embodiments, a single transaction authorization may be required to authorize a plurality of distinct transactions. In one such example, a user may request multiple transactions, e.g., payments to multiple accounts, deliveries to multiple clients/addresses, etc. Such situations often arise in corporate e-banking or logistics applications, for instance. Some embodiments may allow the user to indicate multiple transactions, either one-by-one, or in batches (e.g., by uploading to server 14 a computer file comprising details of multiple transactions). Such transactions may be grouped by server 14 according to various criteria: all payments coming out of the same account, all payments going out to the same client, all payments requested within a time period (e.g., each 10 minute interval), etc. In some embodiments, server 14 may then request a single authorization for each group of transactions. One exemplary embodiment may send a set of transaction tokens to the requesting client system, each transaction token identifying a group of transactions. After verifying the integrity of the secure environment, for each such group of transactions, the server may then send a transaction overview corresponding to each group of transactions to the client system, allowing the user to visually verify the accuracy of each transaction of the respective group. The client system may employ the secure environment to receive from the user an authorization indicator indicating that the user agrees to the respective group of transactions (e.g., the user clicking on an authorization button). In response to receiving a transaction authorization from the secure environment executing on the respective client system, the server may perform all transactions of the respective group.

Implementing a two-part transaction model according to some embodiments of the present invention may allow developers of online commerce products and services to ensure transaction security while still benefiting from existing infrastructure and business models. For example, retail sites may use any existing model of content management, including rich content, publicity ads, special offers, and content from third parties, since such content will be displayed to the user within a typical, off-the-shelf browser (e.g., Internet Explorer®, Firefox®, Safari®, etc.). Typical browsers are fully capable of rendering rich web content, thus generating a pleasant user experience.

Rendering rich web content requires relatively complex software, which may expose a substantial attack surface to malicious agents. In contrast, some embodiments of the present invention use software with a minimal set of features to carry out security-critical activities (e.g., transaction authorization). For instance, the communication application executing within the secure VM may be substantially less complex than a typical browser, since it is used for exchanging data only with a relatively small subset of pre-determined servers. Furthermore, such software may be configured to exclusively use a pre-determined data transfer format and protocol. Therefore, a two-part transaction model as illustrated by some embodiments of the present invention increases security by reducing the attack surface exposed to malicious agents, while also keeping software development and maintenance costs down.

It will be clear to one skilled in the art that the above embodiments may be altered in many ways without departing from the scope of the invention. Accordingly, the scope of the invention should be determined by the following claims and their legal equivalents.

What is claimed is:

1. A server computer system configured to receive transaction requests from a plurality of client systems, and further configured to employ at least one processor of the server computer system to:
in response to receiving a transaction request from a client application executing on a client system of the plurality of client systems, determine whether a transaction indicated by the transaction request requires security clearance; and
when the transaction requires security clearance, send a transaction token to the client system, the transaction token uniquely identifying the transaction among a plurality of transactions;
wherein the client system is configured to, in response to receiving the transaction token, switch to executing a secure virtual machine (VM) having a virtualized processor, and wherein executing the secure VM comprises:
employing the virtualized processor to display an overview of the transaction to a user of the client system,
in response to displaying the overview, employing the virtualized processor to receive a user input indicating that the user agrees to the transaction, and
in response to receiving the user input, employing the virtualized processor to send a transaction authorization to the server computer system, wherein the transaction authorization is required by the server computer system to perform the transaction.

2. The server computer system of claim 1, wherein the client application comprises a web browser application.

3. The server computer system of claim 1, wherein the client application executes within a client VM executing on the client system, the client VM distinct from the secure VM.

4. The server computer system of claim 1, further configured to, in response to receiving an integrity measurement of the secure VM from the client system, determine according to the integrity measurement whether the secure VM is in a trusted state.

5. The server computer system of claim 4, further configured to, in response to determining whether the secure VM is in the trusted state, when the secure VM is in the trusted state, send the overview to the client system.

6. The server computer system of claim 4, further configured to, in response to determining whether the secure VM is in the trusted state, to perform the transaction only when the secure VM is in the trusted state.

7. The server computer system of claim 4, further configured to:
in response to determining whether the secure VM is in the trusted state, when the secure VM is in the trusted state, send a server authentication token to the client system, the server authentication token specified by the user prior to the server computer system receiving the transaction request;
and wherein the secure VM is further configured to display the server authentication token to the user in response to the client system receiving the server authentication token.

8. The server computer system of claim 4, wherein the client system is further configured to cryptographically sign the integrity measurement using a key specific to the client system, and to transmit the signed integrity measurement to the server computer system.

9. The server computer system of claim 1, wherein displaying the overview of the transaction includes receiving the overview from the client application.

10. The server computer system of claim 1, further configured to determine whether the transaction requires security clearance according to a policy determined for the user.

11. The server computer system of claim 10, wherein the policy is determined according to a transaction preference specified by the user.

12. The server computer system of claim 10, wherein the policy is determined according to a set of transactions successfully carried out for the user.

13. The server computer system of claim 1, wherein switching to executing the secure VM comprises transitioning the client system from a state in which a peripheral device used by the client application is in a high-powered condition to a state in which the peripheral device is in a low-powered condition.

14. The server computer system of claim 1, wherein switching to executing the secure VM comprises instantiating a hypervisor on the client system, the hypervisor configured to expose the secure VM.

15. The server computer system of claim 1, wherein the client system is further configured, in response to the secure VM sending the transaction authorization to the server computer system, to terminate the secure VM.

16. The server computer system of claim 1, wherein the transaction request includes an indicator of a transacted item.

17. The server computer system of claim 1, further configured to receive an indicator of a transacted item of the transaction from the client system, and to receive the transaction request in response to receiving the indicator of the transacted item.

18. A non-transitory computer-readable medium storing instructions which, when executed by at least one processor of a client system, cause the client system to form a hypervisor and a virtual machine (VM) launch module, wherein the client system further operates a client application configured to send a transaction request to a remote server computer system, and wherein:
the server computer system is configured to:
in response to receiving the transaction request, determine whether a transaction indicated by the transaction request requires security clearance; and
when the transaction requires security clearance, send a transaction token to the client system, the transaction token uniquely identifying the transaction among a plurality of transactions;
the VM launch module is configured to detect a receipt by the client system of the transaction token; and
the hypervisor is configured to:
expose a secure VM on the client system, the secure VM comprising a virtualized processor, and
in response to the VM launch module detecting the receipt of the transaction token, switch the client system to executing the secure VM, wherein executing the secure VM comprises:
employing the virtualized processor to display an overview of the transaction to a user of the client system,
in response to displaying the overview, employing the virtualized processor to receive a user input indicating that the user agrees to the transaction, and
in response to receiving the user input, employing the virtualized processor to send a transaction authorization to the server computer system, wherein the transaction authorization is required by the server computer system to perform the transaction.

19. The computer-readable medium of claim 18, wherein the client application comprises a web browser application.

20. The computer-readable medium of claim 18, wherein the client application executes within a client VM exposed by the hypervisor on the client system, the client VM distinct from the secure VM.

21. The computer-readable medium of claim 18, wherein the secure VM is further configured to send an integrity measurement of the secure VM to the server computer system, and wherein the server computer system is configured to determine according to the integrity measurement whether the secure VM is in a trusted state.

22. The computer-readable medium of claim 21, wherein the server computer system is further configured, in response to determining whether the secure VM is in the trusted state, when the secure VM is in the trusted state, to send the overview to the client system.

23. The computer-readable medium of claim 21, wherein the server computer system is further configured, in response to determining whether the secure VM is in the trusted state, to perform the transaction only when the secure VM is in the trusted state.

24. The computer-readable medium of claim 21, wherein:
the server computer system is further configured, in response to determining whether the secure VM is in the trusted state, when the secure VM is in the trusted state, send a server authentication token to the client system, the server authentication token specified by the user prior to the server computer system receiving the transaction request;
and wherein the secure VM is further configured to display the server authentication token to the user in response to the client system receiving the server authentication token.

25. The computer-readable medium of claim 21, wherein the secure VM is further configured to cryptographically sign the integrity measurement using a key specific to the client system, and to transmit the signed integrity measurement to the server computer system.

26. The computer-readable medium of claim 18, wherein displaying the overview of the transaction includes receiving the overview from the client application.

27. The computer-readable medium of claim 18, wherein the server computer system is configured to determine whether the transaction requires security clearance according to a policy determined for the user.

28. The computer-readable medium of claim 27, wherein the policy is determined according to a transaction preference specified by the user.

29. The computer-readable medium of claim 27, wherein the policy is determined according to a set of transactions successfully carried out for the user prior to the server computer system receiving the transaction request.

30. The computer-readable medium of claim 18, wherein switching to executing the secure VM comprises transitioning the client system from a state in which a peripheral device used by the client application is in a high-powered condition to a state in which the peripheral device is in a low-powered condition.

31. The computer-readable medium of claim 18, wherein switching to executing the secure VM comprises launching an instance of the hypervisor.

32. The computer-readable medium of claim 18, wherein the hypervisor is further configured, in response to the secure VM sending the transaction authorization to the server computer system, to terminate the secure VM.

33. The computer-readable medium of claim 18, wherein the transaction request includes an indicator of a transacted item.

34. The computer-readable medium of claim 18, wherein the client application is further configured to send an indicator of a transacted item of the transaction to the server computer system, and to send the transaction request in response to sending the indicator of the transacted item.

35. A non-transitory computer-readable medium storing instructions which, when executed by at least one processor of a server computer system configured to receive transaction requests from a plurality of client systems, cause the server computer system to:
in response to receiving a transaction request from a client application executing on a client system of the plurality of client systems, determine whether a transaction indicated by the transaction request requires security clearance; and
when the transaction requires security clearance, send a transaction token to the client system, the transaction token uniquely identifying the transaction among a plurality of transactions;
wherein the client system is configured to, in response to receiving the transaction token, switch to executing a secure virtual machine (VM) having a virtualized processor, and wherein executing the secure VM comprises:
employing the virtualized processor to display an overview of the transaction to a user of the client system,
in response to displaying the overview, employing the virtualized processor to receive a user input indicating that the user agrees to the transaction, and
in response to receiving the user input, employing the virtualized processor to send a transaction authorization to the server computer system, wherein the transaction authorization is required by the server computer system to perform the transaction.
